(19) United States
(12) Patent Application Publication
(10) Pub. No.: US 2025/0051132 A1
(43) Pub. Date: Feb. 13, 2025

(54) METHOD FOR OPERATING AN ELEVATOR FOR MAINTENANCE

(71) Applicant: Inventio AG, Hergiswil (CH)

(72) Inventors: Valerio Villa, Colverde (IT); Erich Butler, Ebikon (CH)

(21) Appl. No.: 18/723,489

(22) PCT Filed: Dec. 16, 2022
(86) PCT No.: PCT/EP2022/086396

§ 371 Date: Jun. 24, 2024

(30) Foreign Application Priority Data
Dec. 31, 2021 (EP) 21218430.3

(51) Int. Cl. B66B 5/00

(52) U.S. Cl. CPC B66B 5/005

(57) ABSTRACT

A method for operating an elevator for maintenance controls the elevator that includes a car being displaceable along an elevator shaft, a drive for displacing the car, a plurality of shaft doors, at least one of the shaft doors being arranged at each of multiple floors along the elevator shaft including at least a lowermost floor and a uppermost floor and an elevator control unit. The elevator control unit performs the method including among other steps, the step of checking whether a person is within a predefined danger zone in the elevator shaft.

### FIELD

The present invention relates to a method for operating an elevator for maintenance. Furthermore, the present invention relates to an elevator configured for executing such a method, to a computer program product and to a computer-readable medium.

### BACKGROUND

An elevator comprises at least one car which may be displaced along an elevator shaft between multiple floors in a building using a drive engine. The car comprises at least one car door which may be opened and closed for providing and blocking access to the car, respectively. At each of the floors, at least one shaft door is provided which may be opened and closed for selectively providing or blocking access to the elevator shaft. The shaft doors are sometimes referred to as landing doors. As long as the car door is not coupled to a shaft door, the shaft door is generally locked in its closed state.

During maintenance of the elevator, a technician requires access to the elevator shaft in order to e.g. be able to inspect an integrity of components of the elevator comprised within the elevator shaft. For such purpose, in conventional elevators, the technician had to call the car to come near to one of the floors and set the elevator in state in which calls from the landing operation panels or a car operation panel were ignored. Then, the technician had to unlock the shaft door. For such unlocking, the technician had to use for example specific tools such as a triangular key. Then, the technician had to manually open the shaft door and e.g. get onto a roof of the waiting car. On the roof a control unit was typically provided. Using the control unit, the technician was able to control the drive engine while in maintenance mode for displacing the car to a desired location. Security measures had to be taken in order to guarantee that the technician was not hurt during such displacing action. For example, it had to be guaranteed that during the maintenance, the car was not driven to a location where the technician either on top of the car's roof or in the pit of the shaft was endangered. Finally, upon having completed the maintenance, the technician had to exit the elevator shaft and manually relock the associated shaft door.

Approaches for opening a locking of a landing door of an elevator are suggested in WO 2017/212105 A1 and WO 2017/212106 A1.

### SUMMARY

There may be a need for an alternative method for operating an elevator for maintenance. Particularly, there may be a need for a method of operating an elevator for maintenance which a safety level for the technician may be increased. Furthermore, there may be a need for an elevator, a computer program product and/or a computer-readable medium configured for implementing such a method.

These needs may be met with the subject-matter of one of the advantageous embodiments defined in the following specification.

According to a first aspect of the present invention, a method for operating an elevator for maintenance is proposed. Therein, the elevator comprises a car and an elevator shaft. The car is displaceable along the elevator shaft. The elevator further comprises a drive for displacing the car. It comprises a plurality of shaft doors, at least one of the shaft doors being arranged at each of multiple floors, including at least a lowermost floor and an uppermost floor. The elevator comprises an elevator control unit, wherein the elevator control unit performs the following steps:
the elevator control unit receives a start-maintenance-request sent by a first entity, wherein the first entity is preferably a first mobile electronic device preferably assigned to a first technician;
the elevator control unit switches from a normal operation mode to a maintenance mode;
assigns a maintenance token to the first entity; further the following steps are performed in the listed order after the before steps were performed:
receives a reassignment-request sent by a second entity, preferably a second mobile electronic device preferably assigned to a second technician;
the elevator control unit verifies that no person is within a predefined danger zone, wherein the predefined danger zone preferably is the elevator shaft;
the elevator control unit assigns the maintenance token to the second entity;
the elevator control unit preferably receives a stop-maintenance-request sent by a second entity; and
the elevator control unit preferably switches from the maintenance mode to the normal operation mode.

The method steps are preferably executed in the indicated order.

With this method, a safe access to the shaft for maintenance is enabled. Furthermore, it is secured that a maintenance can be stopped by another entity (for example if the entity, who started the maintenance is not present anymore). The method makes sure that the entity, who started the maintenance is not within a danger zone when the other (second) entity tries to take over the maintenance access (maintenance token). It is therefore guaranteed, that the elevator can be switched back into a normal operation mode by another entity without putting the entity, who started the maintenance at risk, i.e. reassuming normal operation only when no person is within the danger zone and therefore at risk of being hurt by the elevator. Accordingly, the entire maintenance procedure may be rendered more secure with at the same time providing an option for a forced checkout by a second entity in case of an unforeseen event happens to the first entity, which initiated the maintenance mode.

A start-maintenance-request may be only an information that maintenance is requested. In a preferred embodiment the start-maintenance-request preferably contains information on where the maintenance is intended to take place and on what kind of maintenance is planned, so that depending on the nature of the start-maintenance-request the elevator control unit knows where to displace the car to and where to expect the technician to enter the shaft.

A first entity might be in some cases synonymous with a first person, particularly with a first technician. For communication with the elevator the technician may be represented by a personal mobile electronic device, to which only he has access due to password or a fingerprint or any other equivalent security measure.

A second entity might be in some cases synonymous with a second person, particularly with a second technician, who differs from the first technician. For communication with the elevator the second technician may be represented by a second personal mobile electronic device, which differs from the first electronic device and to which only he has access due to password or a fingerprint or any other equivalent security measure.

A maintenance token is a unique identifier. It can be implemented as a register, in which an ID of an entity is stored. The entity, whose ID is stored in the register is possessing the maintenance token at this moment. The register can be implemented in a way, in which it can only be changed after fulfilling a certain set of preconditions. The registered ID can for example be an IP number of a device. If a certain action is requested by a device the elevator control unit can first compare the requester's ID with the ID stored in the register and therefore check if the action was requested by the holder of the maintenance token. If so, the action can be initiated. If the ID and register value do not correspond, the action is not initiated.

In order to implement a safe method for access to the shaft for maintenance a single maintenance token can exist. This maintenance token can in normal operation be with the elevator control, i.e. in a place where it is stored during normal operation. For the initiation of a maintenance mode the token can be assigned to the entity requesting the maintenance, e.g. the first entity, i.e. the first electronic device. This way it is guaranteed that once the token is with the first entity, no other entity can gain access to/control over the elevator. This way it is guaranteed that the first entity, who might be in the shaft for maintenance is not surprised/endangered by a car movement initiated by another entity.

Once the first entity is done with the maintenance work, the first entity can check out of the maintenance mode and therefore hand back the token to the elevator control unit, which from then on acts as a token storage, till the token again is handed over to an entity requesting maintenance.

There are (emergency) cases in which a second entity might need to take over the maintenance token, for example, to switch the elevator back to normal operation mode, without the presence of the first entity. Such a case might occur if the first entity had an accident. In order to guarantee a secure method a forced but secure take over (reassignment) of the token must be implemented within the elevator control unit. Such a method must make sure that no person is within a predefined danger zone when the maintenance token is taken over by the second entity. After proceeding with such a method, the second entity, who obtained the maintenance token can use it as if it would have initially checked-in to the maintenance method, i.e. as if it would have gotten the token from the elevator control unit directly and not from another entity.

Danger zone means above and in the following a zone in which a person might be endangered during the normal operation of the elevator. A danger zone might be the elevator shaft as whole. Danger zones might also be specific parts of the elevator shaft, parts, such as the top of the car, the top of the elevator shaft, also referred to as head, or the bottom of the elevator shaft, also referred to as pit.

Implementing the method step of checking whether a person is within a predefined danger zone within the elevator control unit has the advantage that the check is performed within the same device as the device, in which all the functions, especially the displacement of the car is performed. Manually tricking the elevator into an unsafe condition by bypassing a remote part of a security system in a way that the control unit does not recognize the presence of people within the shaft is minimized. Said differently, the unit which judges whether a safe state is given and the unit which switches back to normal operation are implemented within the same unit, i.e. the elevator control unit.

A mobile electronic device may be a smartphone or any similar device. Using such a device to send the start-maintenance-request and/or stop-maintenance-request allows to ensure that only the authorized technician who possesses such a device and who is able to unlock the device with a password, via a fingerprint-reader or any other unlock feature is able to send those requests.

The maintenance mode above and in the following refers to a mode which differs from the normal operation mode at least in that calls entered by passengers at landing operation panels and/or a car operation panel are ignored. Accordingly, during maintenance mode, the elevator may not provide any transportation services to passengers. Thus, during maintenance mode, there is no risk of the car being displaced in reaction to a passenger's call.

During normal operation, a shaft door shall exclusively be opened when the elevator car is parked adjacent to a shaft door. In such situation, the car door and the respective shaft door are aligned. However, in order to enable maintenance, exceptions from this rule have to be implemented within the maintenance mode. Particularly, a technician shall be able to access the shaft through a shaft door while the car is not parked directly adjacent to that shaft door.

For safety reasons, the method described above and in the following assures that when the maintenance token is taken over by a second entity, no person is within a danger zone, to which that person might have had access while the first entity possessed the maintenance token.

In a preferred embodiment of the method for operating an elevator for maintenance, the checking whether a person is within a predefined danger zone comprises
measuring a load of the cabin car and comparing the measured load to a threshold value.

For most maintenance work (all maintenance work not performed in the pit), the car is driven to a position where its car door is not aligned with the shaft door but in which its roof is accessible from the shaft door. For example, the cabin car may be displaced and stopped such that its roof is next to a lower end of the shaft door. Accordingly, when the technician enters the elevator shaft, he may step onto the roof of the parked car. During the maintenance, the technician works from car roof. In this condition a load measurement unit of the elevator will measure on top of the usual system weight also the weight of the technician. Measuring the load of the car can thus be used to see whether additional weight has been added to the car, indicating that a person could still be on the car roof. This can be done by comparing the measured value to a non-load value (threshold value) stored within the elevator control unit. Such a non-load value could be a load measured right after the installation of the car or a nominal value of the car, which is known based of the elevator type (no measurement needed). Furthermore, any tools which the technician might have brought with him onto the roof of the car and have been left there would result in a change of the car's weight and therefore could be detected too.

The method increases the safety without the need of any additional sensors, as measuring the load of the car is a necessary measurement during the operation of the elevator, for example to determine a pre-torque-value. Therefore, a load measurement sensor will be available in the elevator anyway. Making use of that already available sensor for ensuring that a technician is not within a predefined danger zone, is a simple and efficient way to increase the security while proceeding to assigning the maintenance token to a second entity.

According to a preferred embodiment of the method for operating an elevator for maintenance, checking whether a person is within a predefined danger zone comprises:
capturing a snapshot of the elevator shaft with a classical camera, a ToF-camera, a thermographic camera and/or a lidar system.

A snapshot above and in the following means the recording of one or several of the above-mentioned cameras/lidar at the certain point in time.

A time-of-flight camera (ToF-camera) is a range imaging camera system that employs time-of-flight techniques to resolve distance between the camera and the subject for each point of the image, by measuring the round trip time of an artificial light signal provided by a laser or an LED. A thermographic camera (also known as infrared camera or thermal imaging camera) is a device that creates an image using infrared radiation, similar to a common camera that forms an image using visible light. Lidar is a method for measuring distances (ranging) by illuminating the target with laser light and measuring the reflection with a sensor. Differences in laser return times and wavelengths can then be used to make digital 3-D representations of the target. All these means are well known to the person skilled in the art.

Capturing and analysing snapshot means above and in the following that certain colors or reflection patterns are identified and analysed toward the possibility of being caused by a person within the predefined danger zone. The use of such snapshots therefore can be used to assess whether it is safe to switch back to normal operation, either alone or in combination with measurements of other sensors such as a load measurement sensor.

The camera(s)/lidar might be located in a part of the shaft, for example in a pit and/or in the head of the shaft or might be attached to the car, for example to the bottom and/or top of the car so that the areas where a person could be endangered can be monitored.

The advantage of using a ToF-camera, a thermographic camera and/or a lidar system instead of a classical camera and/or in combination with a classical camera is that these cameras are much less susceptible to pollution. The dust and dirt within the elevator shaft could over time impact the vision of a classical camera. Any of these cameras is much less prone to such pollution. Such cameras therefore increase the security of the system and also reduces the maintenance/cleaning work required for keeping the system in safe operation.

In an embodiment of the method the checking whether a person is within a predefined danger zone comprises accessing and visually inspecting the lowermost and/or uppermost floor and changing a state of an emergency button at the lowermost and/or uppermost flower respectively if the respective is cleared.

If a state change of the emergency button at uppermost and/or lowermost floor is detected by the elevator control unit, it is certain that a person (second entity) has accessed these areas (head and pit). It can thus be assumed that if there was a person within these areas, these people would have been informed about the reassignment of the maintenance token and any actions possibly following the reassignment (switch back to normal operation mode).

In an embodiment of the method the checking whether a person is within a predefined danger zone comprises accessing the uppermost floor and folding a balustrade from an upright maintenance-position to a downfolded normal-operation-position.

For some maintenance actions it is required to upfold a balustrade. The balustrade comprises switches detecting whether the balustrade is upright or downfolded. If the balustrade is upright, the second entity must fold it down. This way it is secured that someone entered the head area of the shaft and that the car is in a safe state for displacement.

In an embodiment of the method checking whether a person is within a predefined danger zone comprises assigning the maintenance token from the first entity to the second entity via a secure process, preferably a process meeting the SIL3 standard.

There might be cases in which the first entity cannot be at the elevator anymore but other than that can inform the second entity about the state of the elevator. In such a case it might be useful to have a process for assigning the maintenance token to the second entity by a safe process, in which the first entity agrees/initiates such a reassignment.

In a preferred embodiment of the method for operating an elevator for maintenance, the step of verifying that no person is within a predefined danger zone comprises the steps of:
verifying the second entity's presence within the car and/or on a floor before the elevator control unit assigns the maintenance token to the second entity.

Verifying the presence means above and in the following concluding that the technician is in the proximity of the specific part, i.e. within the car or on a floor to a degree where it is possible to conclude that the technician is outside of the elevator shaft. If a technician detected to be in the car, for example by a camera (for example as described above) or by any other sensor, such as a near-field communication sensor that allows to conclude that a human is inside the car, it is safe to assume that it is impossible for him to also be present within the danger zone, i.e. within the elevator shaft. Similarly, this is true if it is possible to identify the technician's presence on a floor. This might be done by a camera or any other sensor, such as a near-field communication sensor, etc. Such a sensor might be part of a landing operating panel or any other parts belonging to the elevator on a floor level.

Detecting the presence of the technician within the car or on a floor is a relatively easy, safe and reliable way of assuring that the technician is not in the shaft anymore, which is useful in case the second entity had to go into the shaft, for example to change the state of an emergency button. In many elevators, such sensors will be implemented within the car and/or on the floor anyway, as the presence of people in the car or on the floor is an information that is used in other parts of the elevator control.

Assigning the maintenance token only after verifying the presence of the technician in the car or on the floor might be an additional safety element to assure that the maintenance does not endanger people. Assuring the presence of the technician within the car or on the floor before assigning the maintenance token is a way of making sure that the maintenance token is not taken away from the first entity without a second (trustworthy) entity being present close to the elevator.

In a preferred embodiment of the method for operating an elevator for maintenance identification of the second entity's presence in the car and/or on a floor is verified by means of
displaying a code on a screen in the car and/or on the floor, which the second entity must scan; and/or
using another camera and/or near field communication device in the car and/or on the floor to identify the second entity;
at least one button on a landing operating panel of the elevator being pressed.

Above and in the following displaying a code, which is then scanned by the technician might be implemented as displaying a changing code, wherein the pattern of the changing code is known to the App the technician is supposed to use to scan the code. The App can assess whether the code that it scans is within the pattern that it should be. Using a dynamic code has the advantage that the code cannot be copied and then scanned from any other location, for example inside of the shaft from another phone, on which a picture of the static code is stored. With a dynamic code, the App can conclude that the person, who scanned the code is present close to the displayed code in the moment of scanning.

The use of a camera in combination with facial recognition or any other kind of identification, such as iris detection and/or a near field communication device which only couples to a specific predetermined other device alternatively or further helps to conclude that the authorized person is within close proximity of that camera and/or near field communication device.

Another option for the control unit to conclude that a technician is present at the elevator site is to wait for a certain elevator button to be pressed. For example, the control unit can wait for a button on the landing operating panel to be pressed twice within a certain period of time or to be pressed within a time limit after the occurrence of an event, such as the closing of a shaft door or receiving a maintenance request, e.g. sent by the second entity.

In a preferred embodiment of the method for operating an elevator for maintenance, the elevator control unit further performs the steps of
distinguishing between at least a first maintenance mode and a second maintenance mode, preferably distinguishing between a first maintenance mode for maintenance at the lowermost floor and a second maintenance mode for maintenance at the uppermost floor; and
   further comprising the step of restricting the displacement of the car in solely a
a upward direction if the first maintenance mode was detected, and/or
a downward direction if the second maintenance mode was detected.

In this embodiment, the security of reassigning a token for maintenance is further increased. If the maintenance was requested at the lowermost floor, the risk of endangering a person within the shaft is the highest in the pit. The resulting danger to crash a technician by moving the elevator car is avoided by initial only allowing an upward movement. As a next step it could be required for the second entity to identify himself at the next higher floor, i.e. at the first floor within the car. In such a case, the method for operating (reassigning a maintenance token) could look like the following, preferably the steps are performed in the following order:
the start-maintenance-request is sent with the information that the first entity wants to perform maintenance in the pit, the elevator control unit displaces the car to a position in which the entrance at the lowermost floor is at least partially cleared so that a technician can comfortably enter the pit,
the technician enters the pit and performs the needed maintenance work,
the technician leaves the pit due to an unforeseen event, such as a medical condition;
a second entity, for example a technician, who came to the elevator site to finish the maintenance/put back the elevator to normal operation mode requests to stop the maintenance and a reassignment-request is sent to the elevator control unit,
the elevator control unit checks whether a person is within a predefined danger zone by any of the means described above or in the following
and/or
by displacing the elevator car in an upward direction to the first floor for the second entity to be able to enter the car there,
the second entity enters the car, the elevator control unit detects by any of the above-described means the presence of the second entity within the car,
knowing that the second entity is an authorized technician, who is allowed to perform actions on the elevator is now within the car one floor above the pit, the elevator control unit assigns the maintenance token to the second entity.

A similar way of reassigning the maintenance token can be performed if the maintenance is requested at the uppermost floor. In this case, the car is restricted to only be able to move downward from the maintenance position. The car can then be stopped at the floor below the uppermost floor. This way the second entity who sent the reassignment-request can identify himself within the car. After the elevator control unit identified the second entity's presence within the elevator car, the control unit can conclude that an authorized person is within proximity of the elevator and is aware of the maintenance actions and the to it connected dangers performed by the first entity.

In another embodiment of the method, the displacement of the car is restricted to a downward displacement for any stop-maintenance-request except if the maintenance was requested at the lowermost floor.

For any other maintenance work within the elevator shaft except the one in the pit it can be assumed that it is the safest to displace the car in a downward direction, as for all of these maintenance-requests the technician will be performing the work on top of the car roof.

In a preferred embodiment of the method for operating an elevator for maintenance as described above and in the following, at least one, preferably all of the shaft doors, have an associated active door drive for opening and closing the shaft door and/or an active door lock for locking and unlocking the shaft door. The method further comprises the steps of:
unlocking and/or opening the specific shaft door by means of the active door lock and/or the active door drive, respectively, so that the technician can access the elevator shaft after the maintenance mode was entered, and/or
closing and/or locking the specific shaft door by means of the active door drive and/or the active door lock, respectively, so that the technician cannot access the elevator shaft anymore before the maintenance token is reassigned.

The use of active door drives/active door locks allows to use the elevator shaft door as an additional security element. The shaft door can be opened by the elevator control unit once the elevator control unit knows that the car has arrived at the predefined position and the elevator shaft therefore is safe to be entered at a specific floor, on which then the elevator control unit unlocks/opens the shaft door via the active door lock/active door drive. At the same time or in addition, an active door drive/active door lock also allows to close a specific elevator shaft door once a request to reassign the maintenance token is received by the elevator control unit. This allows the elevator system to make sure that whatever state within the elevator shaft is present at this point in time cannot be changed from the outside of the elevator shaft anymore. It also allows the elevator control unit to store numbers of the floors on which doors were opened during the maintenance. So that if the reassignment of the maintenance token is requested by the second entity, the elevator control unit can guide the second entity to all of the floors, on which the doors were previously opened. By this the elevator control unit guides the second entity in checking all positions, in which a high risk of endangering a person can be assumed. The elevator control unit can therefore perform/assist/guide the safety check and verify that no person is within the predefined danger zone. If no person is within the predefined danger zone, the elevator control unit can be switched back to the normal operation mode.

In a preferred embodiment also the car door is equipped with an active door drive and/or lock.

In a preferred embodiment, the method as described above and in the following may further comprise the step of assuring that the car is empty after the elevator control unit receives a request to reassign the maintenance token sent by the second entity and before the elevator control unit switches for a normal operation mode to a maintenance mode.

This allows to ensure that no technician (especially the first entity) is trapped within the elevator car before reassigning the maintenance token.

In a preferred embodiment of the method for operating an elevator for maintenance, the elevator control unit prevents the car from being displaced, and/or an elevator brake, preferably a car brake, is engaged during maintenance mode.

In this embodiment, the method is made more secure by either disabling the drive to be activated via the control unit and/or by blocking any movement of the car during the maintenance mode by engaging the brake. With any of the above it can be assured that once before the reassignment of the maintenance token has taken place in a secure way, the elevator car will not be displaced in any direction.

In a preferred embodiment of the method described above and in the following, the method further comprises the step of:
initiating a verification of the braking capability after the maintenance token was reassigned and the maintenance mode was left by request of the new assignee by performing a static brake test.

Both for a safe normal operation mode and a safe maintenance mode, the proper functioning of the elevator brake is required. In the normal operation mode, the brake is required to stop the car at any of the floors. During the maintenance mode, the brake might be required to ensure that the car stays safely at a predefined position. The brake's functioning should therefore be checked whenever it is switched between the two modes and even more so if the switch back to normal operation mode is requested by a different entity (second entity) than the one who initiated the maintenance mode (first entity).

In a preferred embodiment the method for reassigning a maintenance token of an elevator in maintenance mode, which mode was requested at any floor but the lowermost floor comprises the steps of, preferably the steps are performed in the following order,
a technician (first entity) reaches a level other than the lowermost floor, on which he wants to perform maintenance;
the technician sends a start-maintenance-request for a specific maintenance procedure at that floor to the elevator control unit via a mobile electronic device;
the elevator control unit controls the car to be displaced to that level;
the elevator control unit opens the shaft and car doors by controlling an active door drive of the shaft door and controlling an active door drive of the car door;
the technician enters the car to verify that the car is empty;
while the technician is in the car, the elevator control unit confirms his presence;
the technician leaves the car and the elevator control unit closes the shaft door via the active door drive of the shaft door and the car door via the active door drive of the car door;
the elevator control unit controls the car to be displaces to a predefined maintenance position in proximity of that level;
the elevator control unit activates a brake, preferably a car brake;
the elevator control unit measures and stores a pre-maintenance-load, preferably measured by a car load measurement cell;
the elevator control unit assigns a maintenance token to the technician;
the control unit opens the shaft door via the active door drive of the shaft door;
the technician enters the shaft to perform maintenance;
the technician leaves the shaft due to an emergency;
another technician (second entity) comes to the elevator and requests to be the assignee of the maintenance token;
the elevator control unit closes the shaft door by controlling the active door drive of the shaft door;
the elevator control unit measures a post-maintenance-load and compares the value to the stored pre-maintenance-load;
if the values are within a predefined range, the elevator control unit controls the car to be displaced to the next lower floor;
the elevator control unit opens the shaft and car doors by controlling the active door drive of the shaft door and controlling the active door drive of the car door, respectively;
the other technician (second entity) enters the car to confirm his presence inside the car;
the technician leaves the car and the elevator control unit closes the shaft door via the active door drive of the shaft door and the car door via the active door drive of the car door;
the elevator control unit performs a static brake test;
if the brake test is passed, the elevator control unit assigns the maintenance token to the other technician (second entity).

In a preferred embodiment the shaft and/or the car door additionally comprise an active door lock, which unlocks the respective door before it is opened by the respective active door drive and locks the respective door after the door was closed by the respective door drive.

In a preferred embodiment the method for operating an elevator for maintenance at the lowermost floor comprises the steps of, preferably the steps are performed in the following order,
a technician (first entity) reaches the lowermost floor, on which he wants to perform maintenance;
the technician (first entity) sends a start-maintenance-request for a specific maintenance procedure at that floor to the elevator control unit via a mobile electronic device;
the elevator control unit controls the car to be displaced to that level;
the elevator control unit opens the shaft and car doors by controlling an active door drive of the shaft door and controlling an active door drive of the car door;
the technician enters the car to verify that the car is empty;
while the technician is in the car, the elevator control unit confirms his presence;
the technician leaves the car and the elevator control unit closes the shaft door via the active door drive of the shaft door and the car door via the active door drive of the car door;
the elevator control unit controls the car to be displaced to a predefined maintenance position in proximity of that level;
the elevator control unit activates a brake, preferably a car brake;
the elevator control unit measures and stores a pre-maintenance-load, preferably measured by a car load measurement cell;
the elevator control unit assigns a maintenance token to the technician (first entity);
the control unit opens the shaft door via the active door drive of the shaft door;
the technician enters the shaft to perform maintenance;
the technician leaves the shaft due to an emergency;
another technician (second entity) comes to the elevator and requests to be the assignee of the maintenance token;
the elevator control unit closes the shaft door by controlling the active door drive of the shaft door;
preferably the elevator control unit measures a post-maintenance-load and compares the value to the stored pre-maintenance-load;
if the values are within a predefined range, the elevator control unit controls the car to be displaced to the next upper floor, i.e. the first floor;
the elevator control unit opens the shaft and car doors by controlling the active door drive of the shaft door and controlling the active door drive of the car door, respectively;
the other technician (second entity) enters the car to confirm his presence inside the car;
the other technician (second entity) leaves the car and the elevator control unit closes the shaft door via the active door drive of the shaft door and the car door via the active door drive of the car door;
the elevator control unit performs a static brake test;
if the brake test is passed, the elevator control unit assigns the maintenance token to the other technician (second entity).

In a preferred embodiment the shaft and/or the car door additionally comprise an active door lock, which unlocks the respective door before it is opened by the respective active door drive and locks the respective door after the door was closed by the respective door drive.

According to a second aspect of the invention, an elevator is proposed, the elevator being configured to one of executing and controlling the method according to an embodiment of the first aspect of the invention.

In a preferred embodiment the elevator comprises a car being displaceable along an elevator shaft, a drive for displacing the car, an elevator control unit, a plurality of shaft doors, at least one shaft door being arranged at each of multiple floors, preferably each of the shaft doors having an associated active door drive for opening and closing the shaft door and/or active door lock, which can be enabled/disabled by the elevator control unit. The elevator is configured to executing the method as described above and in the following.

An active door lock preferably is a door lock, with a rod and an actuator, preferably an electromagnetic actuator, to move the rod from a locking position into an unlocked position. The active door lock in a preferred embodiment includes a sensor to detect the locked and unlocked position.

In a preferred embodiment the elevator control unit, or at least as a part of it, of the elevator as described above and in the following is configured to fulfil SIL3 requirements.

In the elevator, all components participating in controlling the displacement of the car and/or opening the shaft doors may have to fulfil high safety requirements as defined in the SIL3 (Safety Integrity Level 3) standard. Accordingly, it may be guaranteed that no malfunctions in one of the components may result in creating potentially dangerous situations such as displacing the car while a technician is within the elevator shaft or opening a shaft door while no car has been driven to the predefined position close to the shaft door.

The elevator control unit or any part of it may be programmable. They may have for example a processor for executing computer-readable instructions and/or processing data and a memory for storing the instructions and/or data. Optionally, the door controller may be implemented within the elevator control unit or separate from it. In the latter case, two control units are connected with a data communication link.

According to a third aspect of the invention, the computer program product comprises computer-readable instructions which, when performed by a processor in an elevator according to an embodiment of the second aspect of the invention, instruct the elevator to one of executing and controlling the method according to an embodiment of the first aspect of the invention. Alternatively, the computer program product comprises computer-readable instructions which, when performed by a processor in a mobile data communication device, instruct the mobile data communication device to transmit one of the requesting signal and the finalizing signal for triggering an elevator according to an embodiment of the second aspect of the invention to one of executing and controlling the method according to an embodiment of the first aspect of the invention.

In a preferred embodiment the computer program product comprises computer readable instructions which, when performed by a processor in an elevator as described above and in the following instruct the elevator to one of executing and controlling the method as described above and in the following. Or, alternatively, the computer program product comprises computer readable instructions which, when performed by a processor in a data communication device, instruct the data communication device to transmit a maintenance-request for triggering an elevator as described above and in the following to executing the method as described above and in the following.

A computer program product may be a form of an application (“App”) and may be used to instruct a mobile data communication device such as a smartphone to transmit one of the requesting signal and the finalizing signal for triggering an elevator such that the elevator executes or controls the method proposed herein.

The computer program product comprising the computer-readable instructions may be in any computer-readable language. Upon executing the computer-readable instructions, the elevator control unit performs or controls steps of the method proposed herein.

According to a fourth aspect of the invention, a computer-readable medium is proposed. The computer-readable medium has stored thereon a computer program product according to an embodiment of the third aspect of the invention.

A computer-readable medium comprising the computer program product described above stored thereon may be any portable computer-readable medium such as a CD, a CVD, a flash memory, etc. for transient or non-transient data storage. Alternatively, the computer-readable medium may be a computer or part of a computer network such as a cloud or the Internet, such that the computer program product may be downloaded therefrom.

It shall be noted that possible features and advantages of embodiments of the invention are described herein partly with respect to a method for operating an elevator for maintenance and partly with respect to an elevator configured for implementing such method. One skilled in the art will recognize that the features may be suitably transferred from one embodiment to another and features may be modified, adapted, combined and/or replaced, etc. in order to come to further embodiments of the invention.

In the following, advantageous embodiments of the invention will be described with reference to the enclosed drawing. However, neither the drawing nor the description shall be interpreted as limiting the invention.

### DESCRIPTION OF THE DRAWINGS

FIG. 1 shows an elevator configured for executing a method for operating the elevator for maintenance (reassigning a maintenance token) according to an embodiment of the invention.

The FIGURE is only schematic and not to scale. Same reference signs refer to same or similar features.

### DETAILED DESCRIPTION

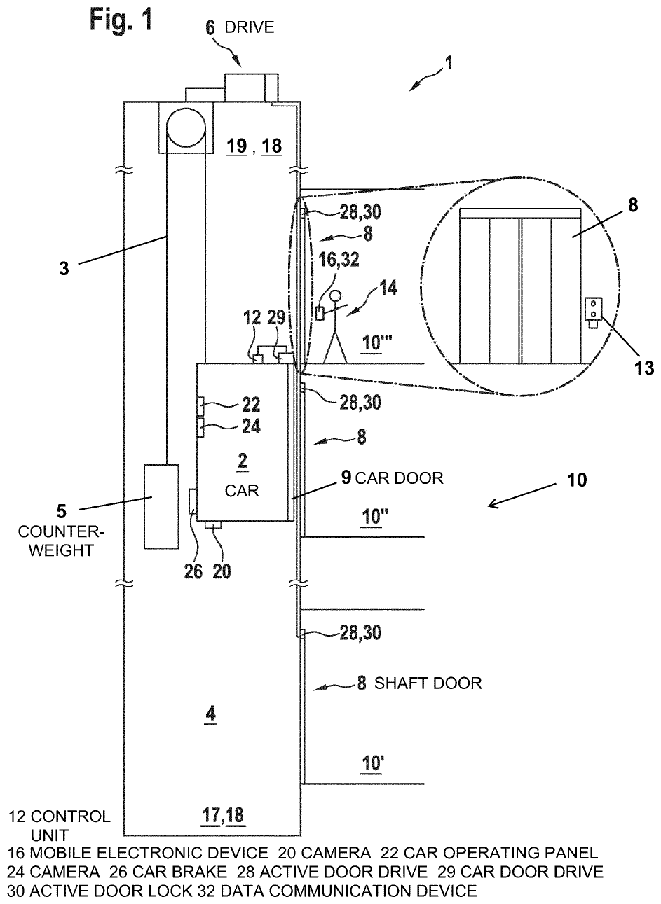

FIG. 1 shows an elevator 1. The elevator 1 is shown in a side view. Furthermore, a portion of the elevator 1 is shown in a front view, as visualized in a partial view inside a dashed frame line.

The elevator 1 comprises a car 2 which is displaceable along an elevator shaft 4. The elevator car 2 is held and displaced by a suspension traction means 3 such as a rope or a belt. At its opposite end, the suspension traction means is coupled to a counterweight 5. The suspension traction means 3 is driven by a drive 6. The drive 6 is controlled by the elevator control unit 12.

The elevator car 2 comprises a car door 9 for opening and closing an access to the elevator car 2. The car door 9 may be opened and closed actively by a car door drive 29. The car door drive 29 is controlled by the elevator control unit 12.

At each of multiple floors 10′, 10″, 10′″, generically floors 10, at least one shaft door 8 is provided. The shaft door 8 may be opened and closed for granting or blocking access to the elevator shaft 4. The elevator 1 presented herein comprises an active shaft door drive 28 at each of the shaft doors 8 for actively opening and closing the respective shaft door 8 by laterally displacing shaft door blades. Each of the door drives 28 is controlled by the elevator control unit 12. It is to be noted, that for reasons of a simpler formation, the terms door drive 28 shall refer herein only to the shaft doors 8, not to the car door 9 (which is equipped with a car door drive 29). An active door lock 30 can be provided at each door 8 in addition to or in place of the active door drive 28. Each of the door locks 30 is controlled by the elevator control unit 12.

Furthermore, at each of the multiple floors 10, a landing operation panel 13 is provided in proximity to the shaft door 8. For example, such landing operation panel 13 may comprise one or more push buttons which may be actuated by passengers for calling the car 2 to come to their floor 10.

During normal operation of the elevator 1, the elevator control unit 12 controls the drive 6 for displacing the car 2 to one of the floors 10 in response to a passenger's call provided by actuating one of the landing operation panels 13. Therein, the drive 6 is controlled such that the car 2 is stopped at the landing position such that its car bottom is substantially on the same height as a bottom at the floor 10 at which the car 2 shall collect or deliver passengers.

For maintenance purposes, the normal operation of the elevator 1 has to be temporarily interrupted. For such purpose, according to the method proposed herein, the technician 14 (first entity) may approach the elevator 1 at one of the floors 10, such as for example the uppermost floor 10″. Upon being close to the shaft door 8 at this floor 10, the technician may send a request for maintenance from a mobile electronic device 16. Such a request is then received by the elevator control unit 12.

When the elevator control unit 12 has received a maintenance-request sent by the technician 14, the drive 6 will control the displacement of the car 2 to a position such that a roof of the car 2 is adjacent to the shaft door 8 at the floor 10 at which the maintenance work requested in the maintenance-request has to be performed (for example the uppermost floor, as shown in FIG. 1). A maintenance token (not shown) is assigned to the technician (first entity). For this maintenance-request, the head 19 of the elevator shaft 4 equals the predefined danger zone 18. Subsequently, the elevator control unit 12 controls the door drive 28 at the respective floor 10″ to actively open the associated shaft door 8. The technician 14 may enter the elevator shaft 4 by stepping on top of the roof of the waiting car 2. At such location, the technician 14 may inspect, modify, repair or replace various components of the elevator 1, such as for example car guide shoes, parts of the elevator control unit, a front bracket fixation, the suspension traction means, a load measuring system and connectors at the counterweight side as well at the car side, counterweight guide shoes, shaft information, a deflection pulley, and/or other components. Due to an emergency the technician 14 might need to leave the elevator 1 without being able to complete the maintenance, i.e. switch the elevator 1 from maintenance mode back to normal operation mode.

Another technician (second entity) (not shown) might be sent to the elevator 1 to continue/finish the maintenance work and assure that the elevator 1 is safely switched back to normal operation mode.

Upon arrival, the other technician may request the reassignment of the maintenance token via a mobile electronic device 16. The other technician may send a reassignment-request with his mobile electronic device 16 in order for the maintenance token to be assigned to him. Upon receiving the reassignment-request, the elevator control unit 12 may control the door drive 28 of the opened shaft door 8 at the floor 10″″ to close this shaft door 8. The elevator control unit 12 displaces the elevator car 2 in a downward direction after the elevator control unit 12 has closed the shaft door 8. As a next step, the other technician has to identify himself within the car being positioned one floor 10″ below the uppermost floor 10″. The elevator control unit 12 therefore opens the respective shaft and the car doors so that the other technician can enter the car 2 and identify himself for example at the car operating panel 22, which may include a camera 24. After this identification, the elevator control unit 12 knows that the other technician, who sent the reassignment-requested is at the elevator 1. It is thus safe for the elevator control unit 12 to assume that the maintenance token can be assigned to the other technician. The other technician and or the elevator control unit 12 can the take other safety measurements to assure that the elevator can be switched back safely into a normal operation mode.

In exemplary embodiment a load-measurement-cell implemented at the car brake 26 may be used to capture a pre-maintenance-status, i.e. pre-maintenance-load-measurement before the maintenance mode is entered and post-reassignment-request-status, i.e. before the maintenance token is reassigned. Before displacing the car to the next lower floor 10″ (see paragraph above) the elevator control unit 12 compares the two load measurements to conclude that they are within a predefined range, e.g. 5% of each other. Only if this is concluded, the car 2 is then moved to the lower floor 10″, where the method continues as described above, i.e. by identification of the other technician inside the car 2.

When the maintenance-request is such that maintenance at the lowermost floor 10′ is requested, the drive 6 will displace the car 2 based on a control of the elevator control unit 12 to a position above the lowermost floor 10′, i.e. such that the car bottom is sufficiently above a pit 17 of the elevator shaft 4, for allowing the technician 14 to enter such a pit 17. For this maintenance-request, the pit 17 equals the predefined danger zone 18. Subsequently, the elevator control unit 12 controls the door drive 28 of the lowermost floor 10′ to actively open the associated shaft door 8. The technician 14 may then enter the pit 17. In the pit 17, the technician may inspect, modify, repair or replace various components of the elevator 1.

Upon having received the request for maintenance (start-maintenance-request), the elevator control unit 12 switches to maintenance mode. In such maintenance mode, calls entered by passengers for example at one of the landing operation panels 13 at any of the other floors or at a car operation panel 22 are ignored. Furthermore, any displacement of the car 2 is prevented as long as the elevator control unit 12 is in the maintenance mode.

In an exemplary, the technician 14 may use a mobile electronic device 16 such as a smartphone to generate and transmit data forming the maintenance-request. For such purpose, a specific application may be programmed and uploaded to the mobile electronic device 16. The electronic mobile device 16 may send electromagnetic waves by a data communication device 32 encrypting the maintenance-request. The electromagnetic waves may be received by a suitable sensor being part or being connected to the elevator control unit 12. Alternatively, the communication link between the mobile electronic device 16 and the elevator control unit 12 could also be established via a server, e.g. a cloud.

Due to an emergency the technician 14 (first entity) might need to leave the elevator 1 without being able to complete the maintenance, i.e. switch the elevator 1 from maintenance mode back to normal operation mode.

Another technician (second entity) (not shown) might be sent to the elevator 1 to continue/finish the maintenance work and assure that the elevator 1 is safely switched back to normal operation mode.

Upon arrival, the other technician may request the reassignment of the maintenance token via a mobile electronic device 16. The other technician may send a reassignment-request with his mobile electronic device 16 in order for the maintenance token to be assigned to him. Upon receiving the reassignment-request, the elevator control unit 12 may control the door drive 28 of the opened shaft door 8 to close this shaft door 8. The elevator control unit 12 displaces the elevator car 2 in an upward direction after the elevator control unit 12 has closed the shaft door 8. As a next step, the other technician, has to identify himself within the car being positioned at the first floor 10″. The elevator control unit 12 therefore opens the respective shaft doors and the car doors so that the other technician can enter the car 2 and identify himself for example at the car operating panel 22, 24. After this identification, the elevator control unit 12 knows that the other technician, who sent the reassignment-requested is at the elevator 1. It is thus safe for the elevator control unit 12 to assume that the maintenance token can be assigned to the other technician. The other technician and or the elevator control unit 12 can then take other safety measurements to assure that the elevator can be switched back safely into a normal operation mode.

In exemplary embodiment a camera 20 may be implemented at the bottom of the car 2 and may be used to capture a pre-maintenance-status, i.e. pre-maintenance-snapshot before the maintenance mode is entered and post-reassignment-request-status, i.e. a post-maintenance-snapshot before the maintenance token is reassigned. Before displacing the car to the next lower floor 10″ (see paragraph above) the elevator control unit 12 compares the two snapshots to concluded that they resemble each other to a degree that the presence of a person in the pit 17 can be negated. Only if this is concluded, the car 2 is then moved to the upper floor 10″, where the method continues as described above, i.e. by identification of the other technician inside the car 2.

Finally, it should be noted that the term “comprising” does not exclude other elements or steps and the “a” or “an” does not exclude a plurality. Also, elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-16. (canceled)

17. A method for operating an elevator for maintenance, the elevator including a car displaceable along an elevator shaft, a drive displacing the car, a plurality of shaft doors, at least one of the shaft doors being arranged at each of multiple floors along the elevator shaft including a lowermost floor and an uppermost floor, and an elevator control unit controlling the elevator in a normal operation mode or in a maintenance mode, the method comprising the steps of:
receiving by the elevator control unit a start-maintenance-request sent by a first entity, wherein the first entity is a first technician using an assigned first mobile electronic device to send the start-maintenance-request;
the elevator control unit switches from the normal operation mode to the maintenance mode in response to the start-maintenance-request;
the elevator control unit assigns a maintenance token to the first entity;
after completing the preceding steps, performing the following steps in order;
receiving by the elevator control unit a reassignment-request sent by a second entity, wherein the second entity is a second technician using an assigned second mobile electronic device to send the reassignment-request;
wherein the elevator control unit checks whether a person is within a predefined danger zone in the elevator shaft;
the elevator control unit assigns the maintenance token to the second entity;
receiving by the elevator control unit a stop-maintenance-request sent by the second entity using the second mobile electronic device; and
the elevator control unit switches from the maintenance mode to the normal operation mode in response to the stop-maintenance-request.

18. The method according to claim 17 wherein the check whether a person is within a predefined danger zone includes measuring a load of the car and comparing the measured load to a threshold value.

19. The method according to claim 17 wherein the check whether a person is within a predefined danger zone includes capturing a snapshot of the elevator shaft with a camera, a TOF-camera, a thermographic camera and/or a lidar system.

20. The method according to claim 17 wherein the check whether a person is within a predefined danger zone includes accessing and visually inspecting the lowermost floor and/or the uppermost floor and changing a state of an emergency button at the lowermost floor and/or the uppermost floor respectively when the respective floor is clear of persons.

21. The method according to claim 17 wherein the check whether a person is within a predefined danger zone includes accessing the uppermost floor and folding a balustrade from an upright maintenance position to a downfolded normal operation position.

22. The method according to claim 17 wherein the check whether a person is within a predefined danger zone includes assigning the maintenance token from the first entity to the second entity by a secure process.

23. The method according to claim 17 wherein the whether a person is within a predefined danger zone includes verifying a presence of the second entity within the car and/or on one of the floors before the elevator control unit assigns the maintenance token to the second entity.

24. The method according to claim 23 wherein the presence of the second entity is verified by identifying the second entity by at least one of:
the second entity scanning a code displayed on a screen in the car and/or on the one floor;
using a camera and/or a near field communication device in the car and/or on the one floor to identify the second entity; and
pressing at least one button on a landing operating panel of the elevator.

25. The method according to claim 17 wherein the elevator control unit performs further steps of:
distinguishing the maintenance mode between a first maintenance mode for performing maintenance at the lowermost floor and a second maintenance mode for performing maintenance at the uppermost floor; and
restricting a displacement of the car solely to an upward direction when operating the elevator in the first maintenance mode, and/or restricting the displacement of the elevator car solely to a downward direction when operating the elevator in the second maintenance mode.

26. The method according to claim 17 wherein at least one of the shaft doors has an associated active door drive for opening and closing the at least one shaft door and/or an active door lock for locking and unlocking the at least one shaft door, and including further steps of:
unlocking and/or opening the at least one shaft door by the active door lock and/or the active door drive after switching to the maintenance mode thereby enabling the first technician to access the elevator shaft; and/or
closing and/or locking the at least one shaft door by the active door drive and/or the active door lock such that the second technician cannot access the elevator shaft before the maintenance token is reassigned.

27. The method according to claim 17 wherein when the elevator is in the maintenance mode, the elevator control unit prevents the drive from displacing the car and/or an elevator car brake of the car is engaged.

28. The method according to claim 17 including initiating verification of a braking capability of the car by performing a static brake test after the maintenance token was reassigned to the second entity and the maintenance mode was left by the second entity.

29. An elevator comprising:
a car displaceable along an elevator shaft;
a drive displacing the car along the elevator shaft;
an elevator control unit;
a plurality of shaft doors, at least one of the shaft doors being arranged at each of multiple floors along the elevator shaft, each of the shaft doors having an associated active door drive for opening and closing the shaft door and/or an active door lock that can be enabled/disabled by the elevator control unit; and
wherein the elevator control unit executes the method according to claim 17 to operate the elevator.

30. The elevator according to claim 29 wherein the elevator control unit is configured to fulfil SIL3 requirements.

31. A computer program product comprising computer readable instructions stored on a non-transitory computer-readable medium, wherein when the instructions are executed by a processor in an elevator control unit of an elevator, the elevator control unit performs the steps of the method according to claim 17.

32. A non-transitory computer readable medium storing the computer program product according to claim 31.

33. A computer program product comprising computer readable instructions stored on a non-transitory computer-readable medium, wherein when the instructions are executed by a processor in a data communication device, the data communication device transmits a start-maintenance-request triggering an elevator control unit to perform the steps of the method according to claim 17.

34. A non-transitory computer readable medium storing the computer program product according to claim 33.
